(19) United States
(12) Patent Application Publication
(10) Pub. No.: US 2024/0240646 A1
(43) Pub. Date: Jul. 18, 2024

(54) SUBSONIC COMPRESSOR, ROTOR BLADE AND METHOD FOR FLOW STABILITY ENHANCEMENT

(71) Applicant: Shandong University of Science and Technology, Qingdao City (CN)

(72) Inventors: Weiwei CUI, Qingdao City (CN); Fei YAO, Qingdao City (CN); Xiaonan WANG, Qingdao City (CN); Changlong RUAN, Qingdao City (CN); Haobo CAO, Qingdao City (CN); Laishun YANG, Qingdao City (CN); Guozhang CHANG, Qingdao City (CN); Cuiping WANG, Qingdao City (CN); Guangxi YUE, Qingdao City (CN)

(73) Assignee: Shandong University of Science and Technology, Qingdao City (CN)

(21) Appl. No.: 18/410,173

(22) Filed: Jan. 11, 2024

(30) Foreign Application Priority Data
Jan. 12, 2023 (CN) 202310064035.0

(51) Int. Cl. F04D 29/28; F04D 17/10

(52) U.S. Cl. CPC F04D 29/284; F04D 17/10

(57) ABSTRACT

A subsonic compressor, a rotor blade and a method for flow stability enhancement are provided. The subsonic compressor includes a hub and a casing, a tip clearance is formed between a tip of the rotor blade and an inner wall of the casing. The tip clearance is formed as a circumferential diverging leakage passage expanding from a pressure surface side of the rotor blade of the subsonic compressor at the tip to a suction surface side of the rotor blade at the tip.

### CROSS-REFERENCE TO RELATED APPLICATION

This patent application claims the benefit and priority of Chinese Patent Application No. 202310064035.0 filed with the China National Intellectual Property Administration on Jan. 12, 2023, the disclosure of which is incorporated by reference herein in its entirety as part of the present application.

### TECHNICAL FIELD

The present disclosure relates to the field of subsonic compressors or gas turbines, and in particular, to a subsonic compressor, a rotor blade and a method for flow stability enhancement.

### BACKGROUND

Regarding significant problems presented in the high loading subsonic compressor, such as flow instability and aggravation of flow loss on the tip of the compressor caused by flow blockage induced by the flow separation near the suction surface at the tip and the leakage flow/vortex, currently, in addition to appropriately unloading or optimizing the streamwise loading distribution of the tip section of the rotor of the subsonic compressor, the main solution to solve these problems is flow control method to effectively suppress the strength of the leakage flow and the degree of flow separation near the suction surface at the tip, so as to delay the occurrence of the rotating stall of the compressor. In the term of the active flow control method, the resistance to interference and separation of the main flow in the tip region are enhanced primarily by means of external energy input such as micro injections, jets, and plasma excitation. In contrast, at present, the passive flow control method such as casing treatment, blade curving and sweep, vortex generators is applied widely. Considering that, at present, the commonly applied active control methods require to be additionally provided external energy required by the flow control and has corresponding actuation and auxiliary mechanisms, etc., the engineering application thereof is limited to some extent, and some passive control methods have problems such as failure in off-design working condition, affecting the overall loading of the blade and interfering the flow of main flow.

Currently, the casing treatment method applied widely, whether an axial groove or an axial skewed slot, significantly improves the stall margin of the axial subsonic compressor, and influences the working efficiency and the pressure-increasing capacity of the tip area of the high loading compressor to some extent. In addition, by arranging a diversion structure near the pressure side edge of blade tip, a separation bubble generated by leakage flow on the blade tip is increased after the gas is guided by the diversion structure, so as to reduce the radial clearance, and the flow rate of the leakage flow and the strength of the leakage vortex are suppressed. However, the method has less effect and is suitable for limited type and condition of compressor.

### SUMMARY

In order to solve one or more technical problems in the prior art, or provide at least one beneficial choice, the embodiments provide a rotor blade for a subsonic compressor, a subsonic compressor, and a method for flow stability enhancement based on obliquely cutting tips, so as to suppress the leakage flow and the flow separation near the suction surface at the tip, improve the tip flow field, delay the stall of the compressor and so on.

In one aspect, the present disclosure provides a rotor blade for a subsonic compressor. The subsonic compressor includes a hub and a casing, a root of the rotor blade is arranged on the hub, a tip clearance is formed between a tip of the rotor blade and an inner wall of the casing, the tip clearance is shaped as a circumferential diverging leakage passage expanding from a pressure surface side of the rotor blade of the subsonic compressor at the tip to a suction surface side of the rotor blade at the tip.

Furthermore, the tip of the rotor blade has an obliquely cut face, and an included angle between the obliquely cut face and the inner wall of the casing is a chamfer angle α, wherein the chamfer angle α is equal to or less than 8 degrees.

Furthermore, a value of the tip clearance between the pressure surface side of the rotor blade at the tip and the inner wall of the casing is not less than a value of a radial clearance in a cold state of a rotor.

Furthermore, the tip of the rotor blade is provided with a first extension surface extending toward the pressure surface side or a second extension surface extending toward the suction surface side.

In another aspect, the present disclosure provides a subsonic compressor, including the rotor blade for the subsonic compressor described above.

In another aspect, the present disclosure provides a method for flow stability enhancement based on obliquely cutting tips, which is applied to a subsonic compressor, the subsonic compressor includes a hub, a casing and rotor blades, a root of each of the rotor blades is provided on the hub, and a tip clearance is formed between a tip of the rotor blade and an inner wall of the casing. The method includes cutting the tip of each of the rotor blades to form the tip clearance as a circumferential diverging leakage passage expanding from a pressure surface side to a suction surface side.

Furthermore, an edge line where a suction surface and a tip end surface of each of the rotor blades intersect with each other is a second cutting line, an edge line where a pressure surface and the tip end surface of each of the rotor blades intersect with each other is a first cutting line, the first cutting line and the second cutting line combine to form a reference stretching surface of the tip, and a leading edge point of the tip and a trailing edge point of the tip are connected to form a tip chord line; cutting the tip comprises following steps: taking the reference stretching surface as a rotating surface and taking the tip chord line as a rotating axis, wherein a forward direction of the rotating axis is directed from the leading edge point to the trailing edge point; rotating the rotating surface in a clockwise direction around the rotating axis to form an oblique cutting surface, wherein an included angle between the oblique cutting surface and the reference stretching surface is a chamfer angle α; and taking the oblique cutting surface as a cutting tool surface to cut the tip of each of the rotor blades.

Furthermore, the chamfer angle α is equal to or less than 8 degrees.

Furthermore, a value of the tip clearance between the pressure surface side of the rotor blade at the tip and the inner wall of the casing is not less than a value of a radial clearance in a cold state of a rotor.

Furthermore, before cutting the tip, the method further comprises following steps: extending the tip of each of the rotor blades toward the pressure surface side to form a first extension surface; or extending the tip of each of the rotor blades toward the suction surface side to form a second extension surface.

By adopting the above-described technical solutions, the embodiments have the following beneficial effects.

1. According to the embodiments, the rotor blade for the subsonic compressor can suppress the flow rate of the clearance leakage flow and the flow separation of the suction surface at the tip by means of reducing the massflow rate of the leakage flow by the circumferential diverging leakage passage which expands from the pressure surface side at the tip to the suction surface side at the tip and is constructed between the obliquely cut tip and casing. Specifically, with regard to the rotor of the subsonic compressor, the velocity of the subsonic clearance leakage jet is reduced by means of the circumferential diverging leakage passage, such that the velocity and range of impact of the leakage jet are reduced, and the velocity and massflow rate of the leakage jet are reduced when it enters the tip passage from the suction surface edge in the clearance area, so as to effectively weaken the strength of the leakage flow and the effects of interference and blockage on the main flow caused by the leakage flow. The local acceleration airflow close to the suction surface and formed between the leakage vortex and the suction surface by the tip flow field can also effectively suppress the flow separation occurring near the suction surface, and the flow blockage effect caused by the flow separation is reduced. Finally, due to the dual suppression effect on the leakage flow and the flow separation near the suction surface, the tip flow characteristic and the steady working margin of the subsonic compressor are obviously improved.

The term “expanding” is understood broadly, and the radial dimension change of the corresponding circumferential diverging flow passage may be linear or nonlinear.

2. As a preferred embodiment, the tip of the rotor blade has an obliquely cut face, and the angle between the obliquely cut face and the inner wall of the casing is a chamfer angle α, in which the chamfer angle α is equal to or less than 8 degrees. According to the embodiments, the tip is formed an obliquely cut face on the tip, such that the embodiments have the advantages of such as simple modification of an original rotor blade, no need to introduce additional energy, an additional actuating device and a mechanism, no need for complex regulation and control strategies, easy implementation and low potential technical risks. By further defining the range of the chamfer angle, it is helpful to optimize various aspects, such as pressurization capability, working margin, and aerodynamic yield in the tip flow field.

3. As a preferred embodiment, the tip clearance is a circumferential diverging leakage passage expanding from the pressure surface side at the tip to the suction surface side at the tip, and the value of the clearance between the pressure surface side of the rotor blade at the tip and the inner wall of the casing is not less than the value of the radial clearance in the cold state of the rotor. By defining the value of the clearance between the rotor-stator interfaces to form the circumferential diverging leakage passage expanding from the pressure surface side at the tip to the suction surface side at the tip, and by suppressing the strength of the leakage flow and the flow separation near the suction face of the tip, the tip flow characteristic and the steady working margin of the rotor of the subsonic compressor can be effectively improved.

4. As a preferred embodiment, the tip of the rotor blade of the compressor is provided with a first extension surface extending toward the pressure surface side. Alternatively, the tip of the rotor blade is provided with a second extension surface extending toward the suction surface side. By providing the first extension surface or the second extension surface, the area of the tip end surface can be increased. On the basis of increasing the area of the tip end surface, the circumferential diverging leakage passage expanding from the pressure surface side at the tip to the suction surface side at the tip is constructed, and the dual suppression effect on the leakage flow and the flow separation near the suction surface at the tip are further improved.

5. The method for flow stability enhancement based on oblique cutting the tip according to the embodiments, by means of the circumferential diverging leakage passage expanding from the pressure surface side at the tip to the suction surface side at the tip constructed by obliquely cutting tip of the rotor blade of the subsonic compressor, can effectively suppress the massflow rate and strength of the leakage flow, significantly reduce the flow separation near the suction surface of the tip, thus, the comprehensive performance and steady working margin of the subsonic compressor are improved. The method has the advantages of such as no need to introduce additional energy, an additional actuating device, and a mechanism, no need for complex regulation and control strategies, easy implementation and low potential technical risks. Compared with other existing passive flow control methods, the embodiments not only suppresses the strength of the tip leakage flow and the flow separation near the suction surface of the high loading subsonic compressor at the tip, and does not have a negative impact on the pressurization capability and working efficiency and so on of the tip flow field of the subsonic compressor, but also can improve the overall performance and working margin of the high loading subsonic compressor to some extent and has significant pneumatic and structural advantages.

6. As a preferred embodiment, the reference stretching surface on the tip of the rotor blade of the compressor is rotated in a clockwise direction around the tip chord line (the forward direction of the rotating axis is directed from the leading edge point to the trailing edge point of the tip) to form the oblique surface (serving as a cutting tool surface), and the rotor blade is cut obliquely, so as to form the circumferential diverging leakage passage expanding from the pressure surface side at the tip to the suction surface side at the tip. The flow stability enhancement and improvement of the tip flow field of each of the subsonic compressors with different loading levels can be achieved, and the application scope is enlarged.

7. As a preferred embodiment, before cutting the tip, the method further includes the following steps. The tip of the rotor blade of the compressor is provided with a first extension surface extending toward the pressure surface side. Alternatively, the tip of the rotor blade is provided with a second extension surface extending toward the suction surface side. By providing the first extension surface or the second extension surface, the area of the tip end surface can be increased. On the basis of increasing the area of the tip end surface, the circumferential diverging leakage passage expanding from the pressure surface side at the tip to the suction surface side at the tip is constructed, and the suppression effect on the leakage flow and the flow separation near the suction surface at the tip are further improved.

### BRIEF DESCRIPTION OF THE DRAWINGS

Drawings herein are used for further understanding of the present disclosure and forming a part of the present disclosure. The exemplary embodiments herein and the description thereof are used to explain the present disclosure rather than to limit the present disclosure. In the drawings:

FIG. 1 is an overall structural schematic view of a rotor for a subsonic compressor according to an embodiment of the present disclosure;

FIG. 2A is a schematic view of a tip clearance of a rotor blade of an unimproved compressor;

FIG. 2B is a schematic view of a circumferential diverging leakage passage of an improved compressor, wherein the circumferential diverging leakage passage expands from a pressure surface side to a suction surface side;

FIG. 3 is a schematic diagram of geometric parameters of a tip of a rotor blade according to an embodiment of the present disclosure;

FIG. 4 is a schematic diagram of an oblique cutting process of a tip of a rotor blade according to an embodiment of the present disclosure;

FIG. 5 is a structural schematic diagram of an obliquely cut tip of a rotor blade according to an embodiment of the present disclosure;

FIG. 6A is a structural schematic diagram of a new tip formed by stretching a tip of a rotor blade towards a pressure surface side so as to increase an area of the tip according to an embodiment of the present disclosure;

FIG. 6B is a structural schematic diagram of a new tip formed by stretching a tip of a rotor blade towards a suction surface side so as to increase an area of the tip according to another embodiment of the present disclosure;

FIG. 7A is a graphical comparison of isentropic efficiency as a function of massflow rate for a tip oblique-cutting solution and a prototype solution;

FIG. 7B is a graphical comparison of total pressure ratio as a function of massflow rate for the tip oblique-cutting solution and the prototype solution;

FIG. 8 is a schematic view of a distribution contour of the relative Mach number of the tip clearance flow field of the tip oblique-cutting solution and the prototype solution in near-stall condition;

FIG. 9 is a schematic diagram of distribution of three streamwise positions in tip clearance over blade tip;

FIG. 10A is a graphical comparison of leakage velocity distribution at a first position in FIG. 9 (corresponding to line 3) in a tip clearance passage (perpendicular to the chordwise direction) for the tip oblique-cutting solution and the prototype solution;

FIG. 10B is a graphical comparison of leakage velocity distribution at a second position in FIG. 9 (corresponding to line 4) in the tip clearance passage (perpendicular to the chordwise direction) for the tip oblique-cutting solution and the prototype solution;

FIG. 10C a graphical comparison of leakage velocity distribution at a third position in FIG. 9 (corresponding to line 5) in the tip clearance passage (perpendicular to the chordwise direction) for the tip oblique-cutting solution and the prototype solution; and

FIG. 11 is a variation graph of blockage effect of a tip clearance flow field of an obliquely cut tip of a rotor blade.

### REFERENCE NUMERALS

1 casing revolution surface; 2 rotor blade; 3 hub revolution surface; 4 first cutting line; 5 tip end surface; 6 second cutting line; 7 tip chord line; 8 leading edge line; 9 trailing edge line; 10 reference stretching surface; 11 oblique cutting surface; 13 chamfer angle; 14 new tip end surface; 121 suction surface; 122 pressure surface; 21 first extension surface; 22 second extension surface; and 110 circumferential diverging leakage passage.

### DETAILED DESCRIPTION OF THE EMBODIMENTS

In order to explain the overall concept of the present disclosure more clearly, the following detailed description is given by way of example in conjunction with the accompanying drawings.

To make the foregoing objectives, features, and advantages of the present application clearer, the following further describes the present disclosure in detail with reference to the accompanying drawings and specific embodiments. It should be noted that the embodiments of the present application and the features in the embodiments can be combined with each other without conflict.

It should be noted that, in the following description, specific details are set forth to facilitate a thorough understanding of the present disclosure. However, the present disclosure may also be implemented in other manners different from those described herein. Therefore, the scope of the present disclosure is not limited to the specific embodiments disclosed below.

In addition, in the description of the present disclosure, it should be understood that the orientation or position relations indicated by the terms “center”, “upper”, “lower”, “front”, “rear”, “left”, “right”, “vertical”, “horizontal”, “top”, “bottom”, “inner”, “outer”, “axial”, “radial”, “circumferential” and so on are based on the orientation or position relations shown in the accompanying drawings, it is only for convenience in describing the present disclosure and simplifying the description, rather than indicating or implying that the indicated device or element must have a particular orientation, be constructed and operated in a particular orientation, therefore, it cannot be understood that the present disclosure is limited thereto.

In addition, terms such as “first” and “second” are used herein for purposes of description and are not intended to indicate or imply relative importance or significance or to imply the number of indicated technical features. Thus, the features defined by “first” and “second” may explicitly or implicitly include one or more of the features. In the description of the present disclosure, “a plurality of” means two or more than two, unless specified otherwise.

In the present disclosure, unless specified or limited otherwise, the terms “mount”, “join”, “connect”, “fix” and so on are understood broadly, and may be, for example, fixed connections, detachable connections, or integral connections; may also be direct connections or indirect connections via intervening structures; may also be inner communications or interaction relationships of two elements. However, it is noted that a direct connection indicates that a connection relationship is not established between two connected bodies via a transition structure, and the two connected bodies are connected to form a whole via only a connection structure. The specific meanings of the above terms in the present disclosure can be understood by those skilled in the art according to specific situations.

In the present disclosure, unless specified or limited otherwise, a first feature is located “above” or “below” a second feature may include an embodiment in which the first feature is in direct contact with the second feature, and may also include an embodiment in which the first feature and the second feature are in indirect contact via an intermediary. In the description of the specification, this description relating to terms “an embodiment”, “some embodiments”, “an example”, “a specific example”, or “some examples” means that a particular feature, structure, material, or characteristic described in conjunction with the embodiment or example is included in at least one embodiment or example of the present disclosure. Thus, the schematic description about terms mentioned above in this description are not necessarily referring to the same embodiment or example of the present disclosure. Furthermore, the particular features, structures, materials, or characteristics described may be combined in any suitable manner in one or more embodiments or examples.

It is an inevitable trend for future development of high thrust-to-weight ratio acro-engines by increasing the stage pressure ratio of the compressor to reduce the stage number and weight of the compression components. However, the increase of the stage pressure ratio of the compressor significantly increases the loadings on elementary stages at different span of the rotor blade, and also continuously increases the static pressure difference between two sides of the blade, such that the three-dimensional flow field in the compressor becomes more complex. Especially in a tip area of the rotor of the compressor, a strong leakage flow is induced in a clearance area of the rotor blade under the driving of a relatively large static pressure difference between the two sides of the tip, and the leakage flow interferes with the secondary flow of the passage and the boundary layer near the suction surface, and shears with the main flow, which will induce a relatively large low velocity zone in the tip flow field of the rotor of the compressor. The leakage flow and the flow separation near the suction surface of the compressor at the tip are major contributors to induce the deterioration of the tip flow field and rotating stall of the high loading compressor.

The present disclosure relates to a rotor for a subsonic compressor. Without the injection of external energy, and without the addition of an accompanying mechanism or an actuating device, a circumferential diverging leakage flow passage structure expanding from a pressure surface side at the tip to a suction surface side at the tip is constructed by means of obliquely cutting tips, so as to reduce the velocity of a subsonic leakage jet in a clearance area. By means of the effect of reducing the velocity of the subsonic leakage jet in the circumferential diverging clearance leakage passage, the jet velocity and massflow rate of the leakage flow when it enters the tip passage from the suction surface side edge in the clearance area can be effectively reduced. By means of a local acceleration airflow formed between the low-velocity zone caused by leakage vortex and the suction surface, the flow separation near the suction surface of the rotor at the tip is effectively suppressed, so as to effectively reduce the blockage effect of the tip flow of the rotor induced by the leakage flow and the flow separation near the suction surface, and finally achieve a significant improvement of the tip flow field characteristic and steady working margin of the subsonic compressor.

The method for flow stability enhancement of the subsonic compressor based on obliquely cutting tips of the rotor blade provides a reference or reference concept for the optimization design of a rotor blade of a high-performance compressor, can be used as a key geometric optimization factor for optimizing the tip flow field characteristic of the subsonic compressor, and has an important supporting effect on improving the comprehensive aerodynamic performance of the subsonic compressor.

The method for flow stability enhancement of the subsonic compressor based on obliquely cutting tips of the rotor blade of the present disclosure is not only applicable to a subsonic compressor stage of an acro-gas turbine, but also applicable to a compression component of a ground/ship gas turbine, an industrial ventilation machine, a mine blower and a pressure expansion impeller machine in the chemical industry and so on.

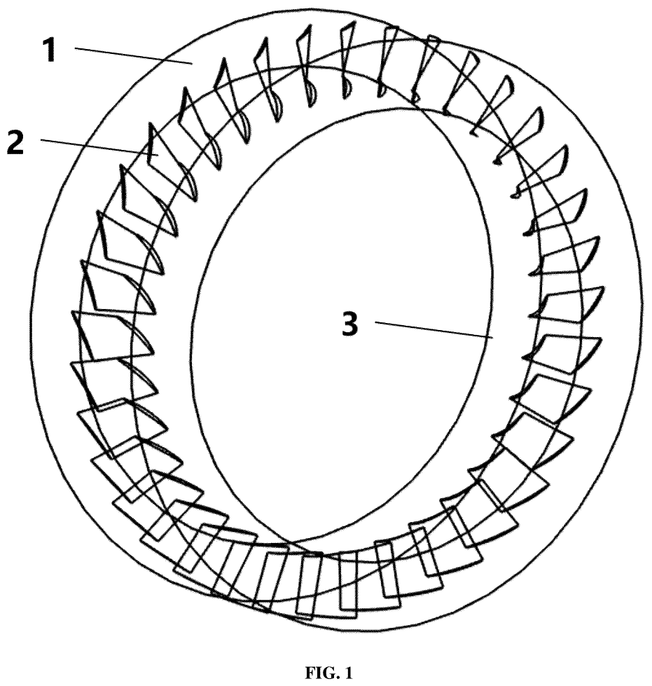

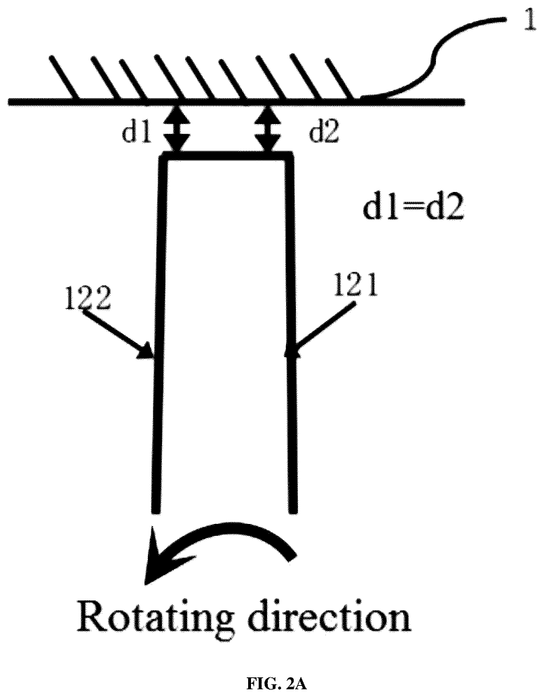

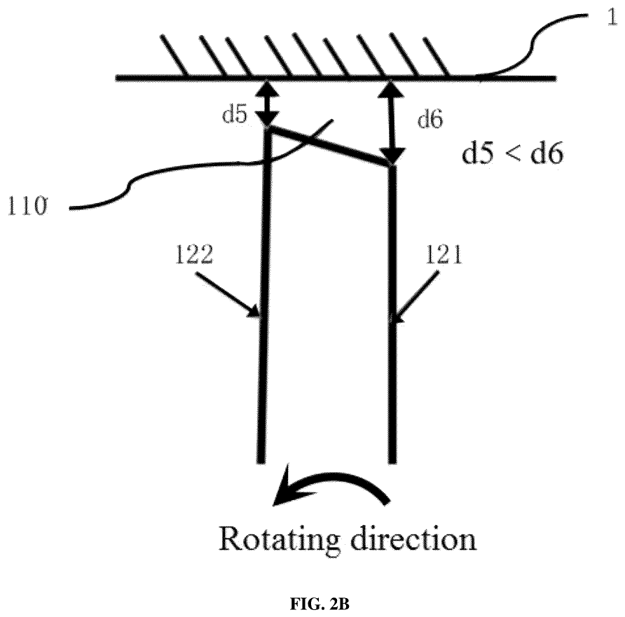

As shown in FIGS. 1, 2A and 2B, the rotor for the subsonic compressor includes a casing revolution surface 1, a hub revolution surface 3 and rotor blades 2, roots of the rotor blades 2 are arranged on the hub revolution surface 3, and a tip clearance is formed between tips of the rotor blades 2 and an inner wall of the casing revolution surface 1. The rotor blade 2 has a suction surface 121 and a pressure surface 122. Generally, as shown in FIG. 2A, the tip clearance is uniform, i.e., d1=d2. In the present disclosure, by modifying a tip structure of the rotor blade 2, a circumferential diverging leakage passage 110 expanding from a pressure surface side at the tip to a suction surface side at the tip as shown in FIG. 2B may be formed, in which d6>d5.

On the basis of the original structure of the rotor blade 2, the tip structure of the rotor blade 2 is cut obliquely, such that the tip clearance in FIG. 2B is formed the circumferential diverging leakage passage expanding from the pressure surface side to the suction surface side, thus the flow separation near the suction surface at the tip and the massflow rate of the leakage flow of the subsonic compressor can be suppressed, the blockage effect of the clearance leakage jet and the flow separation of tip on the tip passage is weakened, and a significant improvement of the tip flow characteristic and the steady working margin of the subsonic compressor is finally achieved. Specifically, for the subsonic compressor, by constructing the circumferential diverging leakage passage 110 expanding from the pressure surface side of the rotor blade at the tip to the suction surface side of the rotor blade at the tip at the tip of the rotor blade, the massflow rate of the subsonic clearance leakage flow continuously decreases as the through-flow cross section areas in the circumferential diverging leakage passage continuously increase, and the strength of the leakage flow and the interference thereof on the tip passage is effectively suppressed. A local acceleration airflow is formed between the reduced low-velocity zone caused by the weakened tip leakage vortex and the suction surface, which effectively suppresses the flow separation near the suction surface of tip. On this basis, by means of the circumferential diverging leakage passage of the tip of the rotor, the flow separation near the suction surface and the tip leakage flow can be suppressed and a significant improvement of the tip flow characteristic and the comprehensive performance of the subsonic compressor is finally achieved.

In the present disclosure, the circumferential diverging leakage passage 110 expanding from the pressure surface side at the tip to the suction surface side at the tip is constructed by means of obliquely cutting the tip of the rotor blade, and the specific oblique cutting method is as follows. According to the description of the embodiments of the present disclosure, taking the rotor of the subsonic axial compressor as an example, it can be understood that the implemented object is not limited to the rotor of the subsonic axial compressor, and may also be such as the subsonic centrifugal, oblique flow, combined compressor and industrial fan.

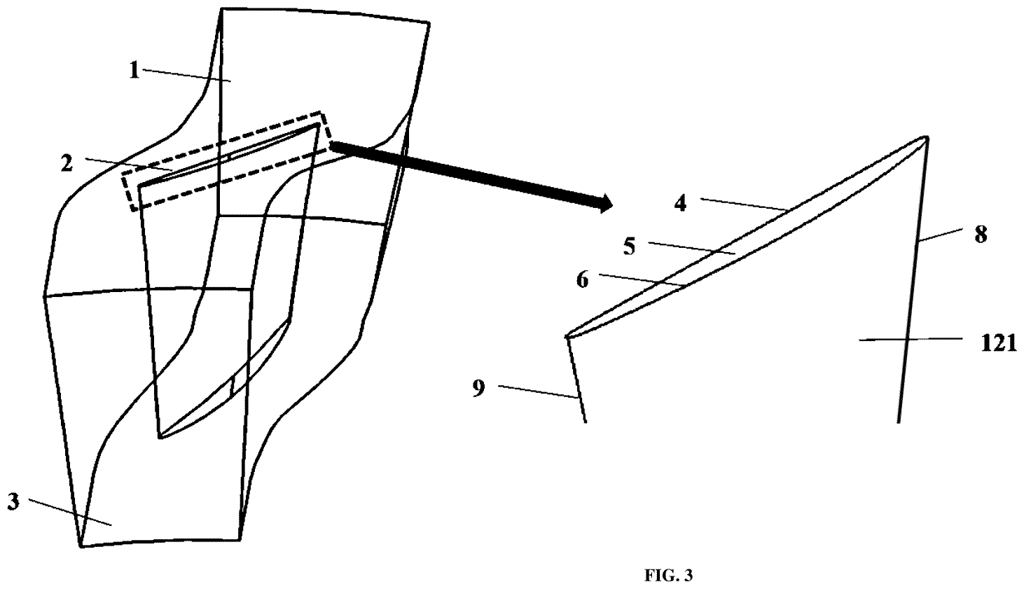

As shown in FIG. 3, such as the positions of a suction face 121, a pressure face 122, a tip end surface 5, a leading edge line 8 and a trailing edge line 9 of a three-dimensional blade of a rotor for the subsonic compressor are defined.

Furthermore, an edge line where the suction surface 121 and the tip end surface 5 intersect with each other is taken as a second cutting line 6, an edge line where the pressure surface 122 and the tip end surface 5 intersect with each other is taken as a first cutting line 4, the first cutting line 4 and the second cutting line 6 are combined to form a reference stretching surface 10 of the tip, and a leading edge point and a trailing edge point of the tip is connected to form a tip chord line 7.

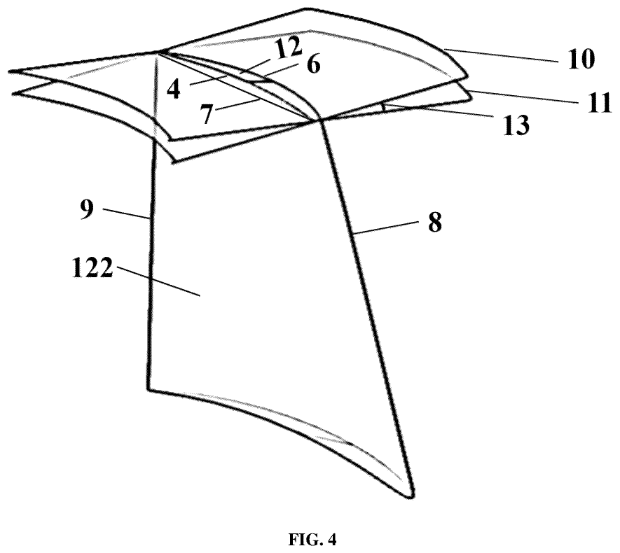

Furthermore, as shown in FIG. 4, the reference stretching surface 10 serves as a rotating surface, and the tip chord line 7 serves as a rotating axis, such that the rotating surface rotates in a clockwise direction around the rotating axis (the forward direction of the rotating axis is directed from the leading edge point to the trailing edge point) to form an oblique cutting surface 11, and the oblique cutting surface 11 and the reference stretching surface 10 form a chamfer angle 13, that is, a chamfer angle α.

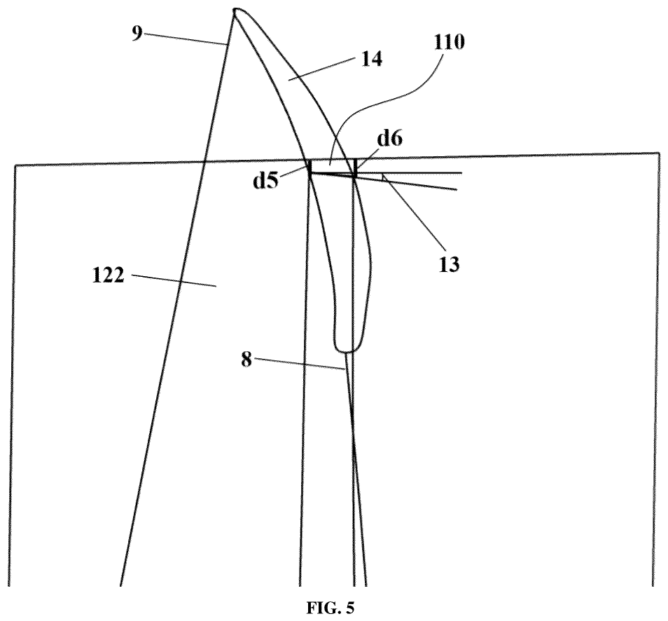

Furthermore, as shown in FIG. 5, the oblique cutting surface 11 serves as a cutting tool surface for cutting the tip of the rotor blade. After a small amount of a geometric part of the tip outside the oblique cutting surface is cut off, a new tip end surface 14 is formed on the tip of the rotor blade of the subsonic compressor. A circumferential diverging leakage passage 110 expanding from a pressure surface side at the tip to a suction surface side at the tip is formed between the new tip end surface 14 and the casing revolution surface 1, and the corresponding included angle of the clearance passage is the chamfer angle 13, that is, the chamfer angle α.

Preferably, the chamfer angle α is equal to or less than 8 degrees. It will be understood that the chamfer angle is not limited to the angle range and is determined depending on the ultimate tip flow field configuration and aerodynamic benefits.

Preferably, the value of the clearance between the pressure surface side of the rotor blade at the tip and the inner wall of the casing is not less than the value of the radial clearance in the cold state of the rotor. That is, while taking into account the effect of improving the aerodynamic performance, by reasonably adjusting the value of the chamfer angle α, it is ensured that d5 is not less than the value of the radial clearance in the cold state of the rotor not subjected to the oblique-cutting treatment.

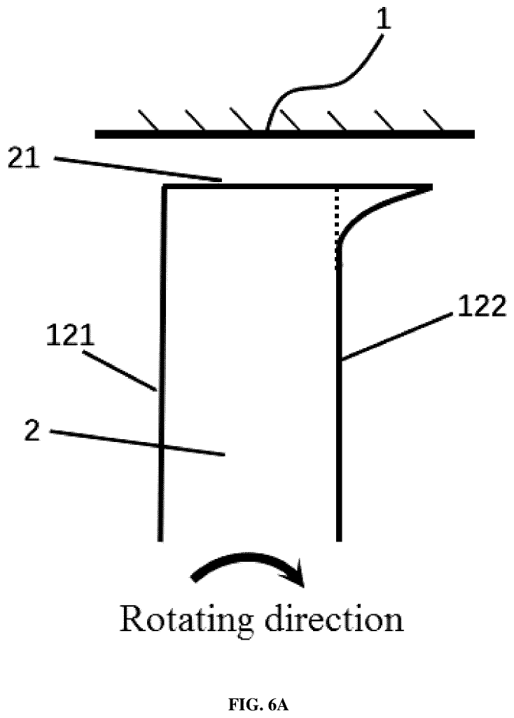

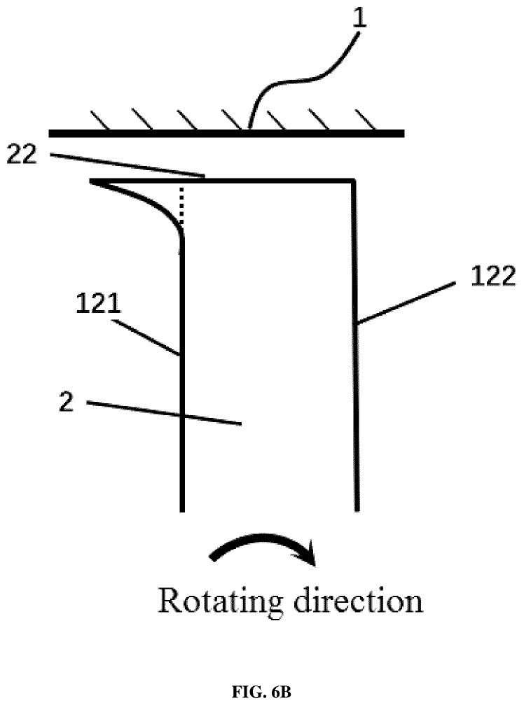

On the basis of the embodiment described above, in order to further optimize the dual suppression effect of the circumferential diverging clearance passage on the clearance leakage flow jet and the flow separation near the suction face of the tip, before cutting the tip, the area of the tip end surface can be increased (corresponding to increasing the thickness of the blade shape of the elementary stage of the tip of the rotor blade). As shown in FIG. 6A, the tip of the rotor blade 2 expands towards the pressure surface side to form a first extension surface 21, that is, a new tip of the rotor blade with a larger end surface area. The new tip is cut obliquely to form a circumferential diverging leakage passage expanding from the pressure surface side at the tip to the suction surface side, such that the dual suppression effect of the circumferential diverging clearance structure on the strength of the tip leakage flow and the flow separation near the suction surface can be further improved.

On the basis of the embodiment described above, in order to further optimize the suppression effect of the circumferential diverging clearance passage on the clearance leakage flow jet and the flow separation near the suction face of the tip, before cutting the tip, the area of the tip end surface can be increased (corresponding to increasing the thickness of the blade shape of the elementary stage of the tip of the rotor blade). As shown in FIG. 6B, the tip of the rotor blade 2 expands towards the suction face side to form a second extension surface 22, that is, a new tip of the rotor with a larger end surface area. The new tip is cut obliquely to form a circumferential diverging leakage passage expanding from the pressure surface side at the tip to the suction surface side, such that the dual suppression effect of the circumferential diverging clearance structure on the strength of the tip leakage flow and the flow separation near the suction surface can be further improved.

On the basis of the new method for the flow stability enhancement of the subsonic compressor of the present disclosure, the present disclosure may provide an improved rotor blade. The method of oblique-cutting tips may be integrated into the three-dimensional modeling of the rotor blade of the subsonic compressor and is served as a adjustability geometric parameter of a blade design. Furthermore, the present disclosure may provide a subsonic compressor according to the described improved rotor blade, so as to improve the overall performance of the subsonic compressor.

Embodiment 1: a rotor for a subsonic axial subsonic compressor of grade 1.5 is taken as an implementation object, the tip of the rotor blade is obliquely cut, and the aerodynamic performance of the rotor is verified. In particular, the chamfer angle α is taken to be 6 degrees, and it is ensured that the design clearance and the tip clearance at a pressure surface side of the rotor blade at the tip remain unchanged.

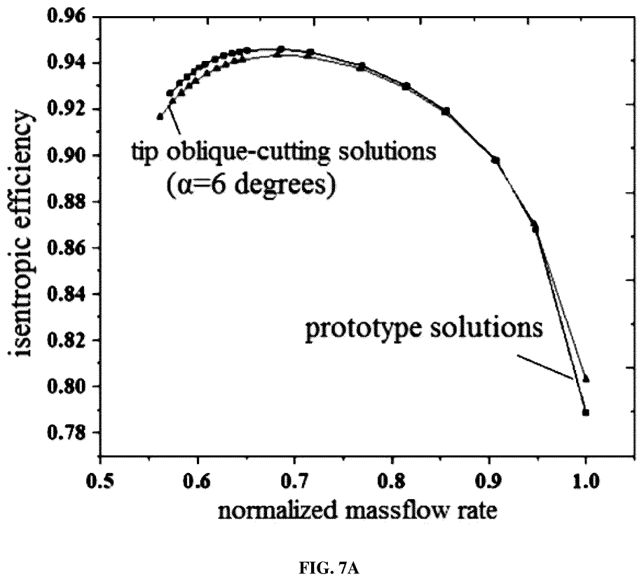

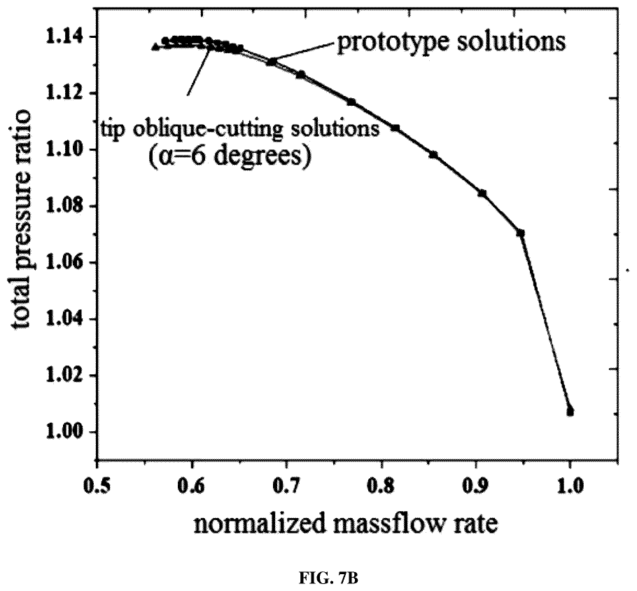

As shown in FIGS. 7A and 7B and Table 1, after the tip oblique-cutting solution is applied, the steady working margin of the rotor of the subsonic axial compressor at the designed rotating rate is improved by 3.6% relative to the prototype solution.

TABLE 1
Comparison of pneumatic performance of the tip oblique-cutting solution
and the prototype solution at the designed rotating rate

| | | Massflow | | | |
|---|---|---|---|---|---|
| | | rate at a | Total | Total | |
| | Massflow | point | pressure | pressure | |
| | rate at a | in near- | ratio | ratio | |
| | design | stall | at a | in near- | |
| | point | condition | design | stall | Working |
| Solution | (kg/s) | (kg/s) | point | condition | margin |
| Prototype | 15.191 | 11.2868 | 1.1169 | 1.1385 | 27.1% |
| solution | | | | | |
| Tip oblique- | 15.1621 | 11.0877 | 1.1166 | 1.1361 | 28.1% |
| cutting | | | | | |
| solution | | | | | |
| (α = 6 degrees) | | | | | |

A calculation formula of the working margin based on the highest efficiency point is as shown in formula (1):

$$ε = 1 - \frac{{G}_{N S}}{{G}_{P E}} \times \frac{{π}_{P E}}{{π}_{N S}} \qquad ( 1 )$$

In which,
G_{Ns} is the massflow rate at a near-stall point;
G_{PE} is the massflow rate at a peak-efficiency point;
π_{PE} is the total pressure ratio at the peak-efficiency point; and
π_{NS} is the total pressure ratio at the near-stall point.

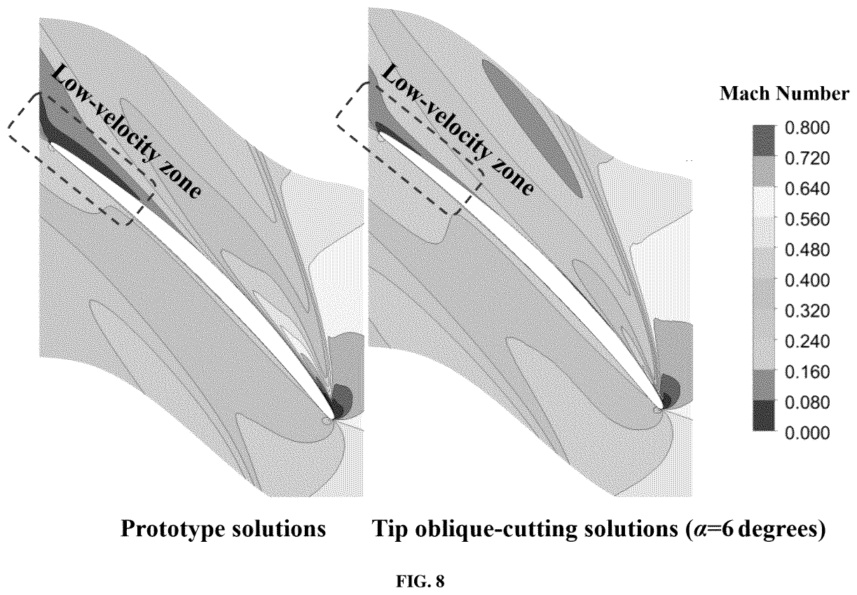

Furthermore, FIG. 8 shows the effect of the treatment method of obliquely cutting tips on an internal flow field of the rotor for the subsonic axial compressor. After the tip oblique-cutting solution is applied, the included angle between the track of the leakage flow and the suction surface of the blade is obviously reduced, which fully indicates that the strength of the leakage flow is obviously weakened, and the flow separation area near the suction surface of the rotor of the compressor at the tip after the tip oblique-cutting solution is performed is obviously suppressed. The change of the tip flow field of the compressor fully indicates that, after the circumferential diverging clearance leakage passage expanding from the pressure surface side to the suction surface side is constructed on the tip of the rotor blade of the compressor by means of cutting the tip of the rotor blade obliquely, both the strength of the leakage flow of the compressor rotor and the flow separation near the suction surface at the tip are significantly suppressed, which is a fundamental reason why the steady working margin of the rotor of the subsonic compressor is improved.

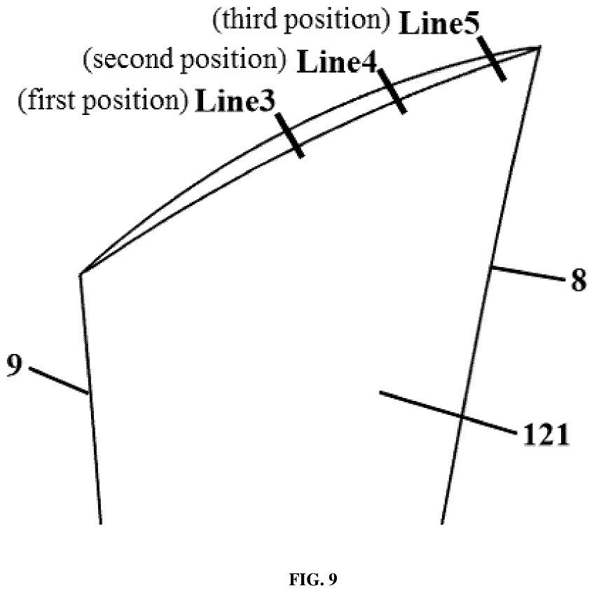

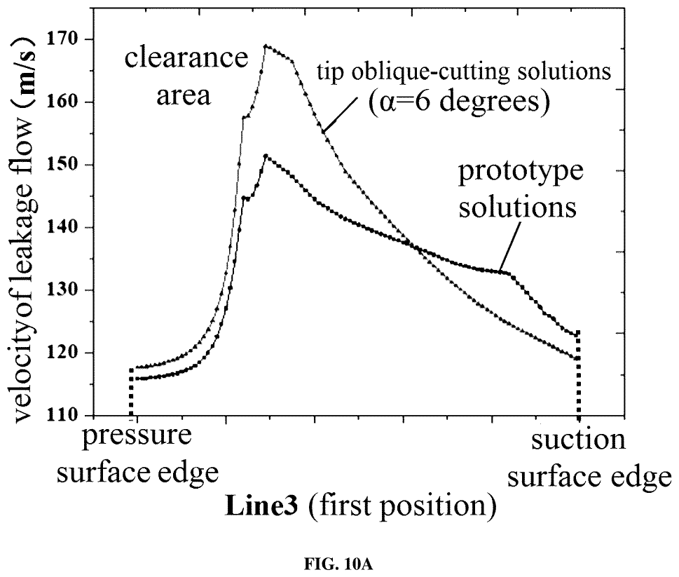

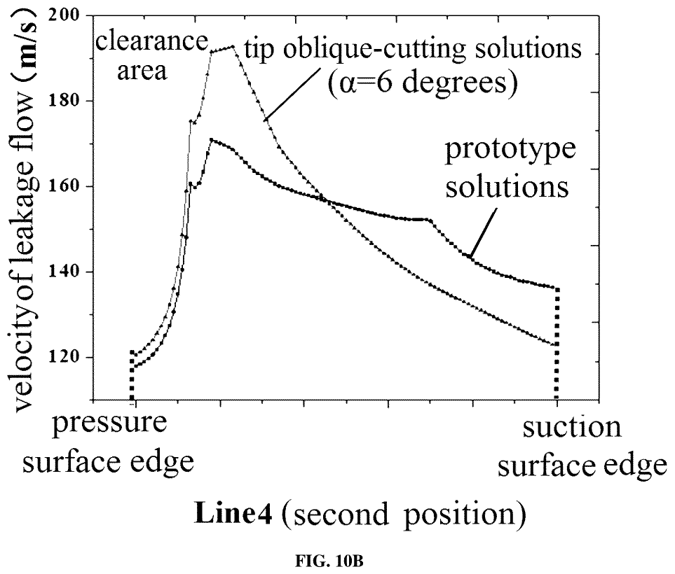

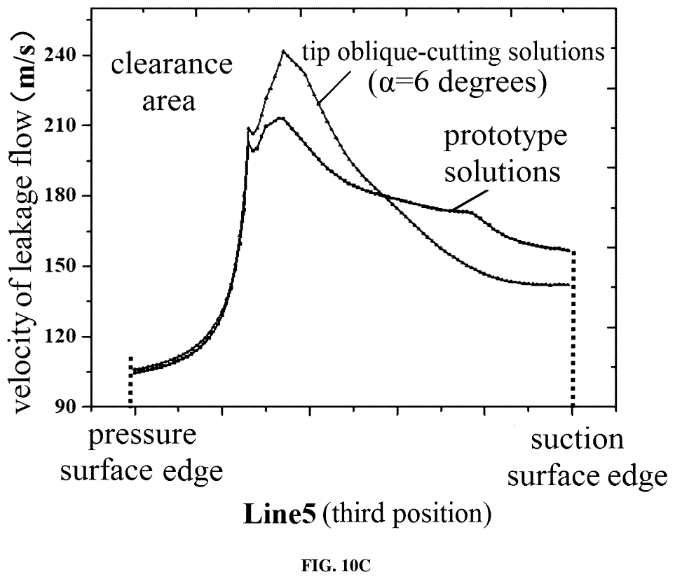

Furthermore, FIGS. 9, 10A, 10B and 10C show the leakage velocity distribution from the pressure surface side to the suction surface side at positions with different chord lengths on the tip of the rotor in near-stall condition for the tip oblique-cutting solution and the prototype solution. As can be seen from FIGS. 10A, 10B, and 10C, after the tip oblique-cutting solution is applied, the outlet jet velocity of the leakage flow in the circumferential diverging tip clearance expanding from the pressure surface side at the tip to the suction surface side at the tip is significantly reduced. Table 2 is a comparison of the massflow rate of the tip leakage flow in near-stall condition for the tip oblique-cutting solution and the prototype solution. After the tip oblique-cutting solution is applied, due to the decrease in the jet velocity of the clearance leakage flow, the massflow rate of the leakage flow of the rotor of the subsonic compressor is also significantly reduced, such that the strength of the leakage flow is effectively suppressed, which is one reason why the steady working margin of the rotor of the subsonic compressor increases caused by the obliquely cut tip structure.

TABLE 2
Comparison of the massflow rate of the leakage
flow in near-stall condition for the tip oblique-
cutting solution and the prototype solution.

| | Massflow rate of tip |
|---|---|
| Solution | clearance leakage flow |
| Prototype solution | 0.0035479 kg/s |
| Tip oblique-cutting solution | 0.0017493 kg/s |
| (α = 6 degrees) | |

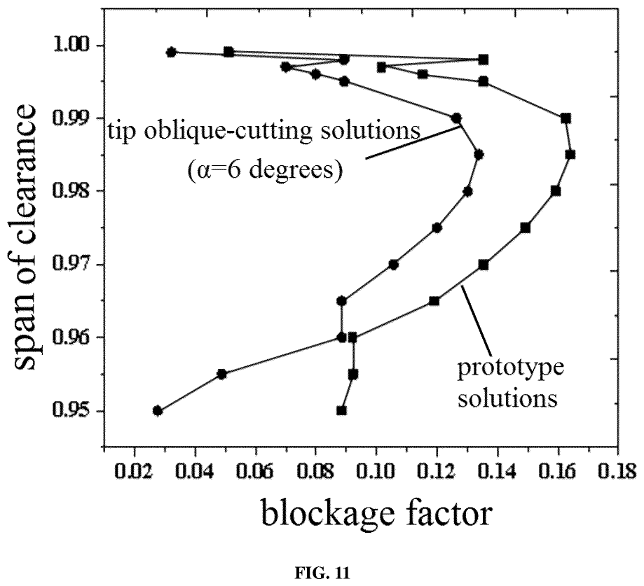

Furthermore, as shown in FIG. 11, by means of the effect of reducing the jet velocity of the subsonic leakage flow in the circumferential diverging clearance leakage passage, the jet velocity and the massflow rate of the leakage flow when it enters the tip passage from the suction surface side edge in the clearance area can be effectively reduced. By means of a local acceleration airflow formed between the low-velocity zone caused by leakage vortex and the suction surface, the flow separation near the suction surface of the rotor at the tip is effectively suppressed, so as to effectively reduce the blockage effect of the tip passage of the rotor induced by the clearance leakage flow and the flow separation near the suction surface, and a significant improvement of the tip flow field characteristic and steady working margin of the subsonic compressor is finally achieved.

Based on the method for flow stability enhancement of a subsonic compressor of the present disclosure, by constructing the circumferential diverging clearance leakage flow passage structure expanding from the pressure surface side of the rotor blade of the subsonic compressor at the tip to the suction surface side of the rotor blade of the subsonic compressor at the tip, the dual control of the strength of the tip leakage flow of the rotor and the flow separation near the suction surface at the tip in high loading condition can be achieved, and the tip flow characteristic and the steady working range of the subsonic compressor is effectively improved.

The technical solution of the present disclosure is not limited to the above embodiments, and it should be pointed out that the combination of the technical solution of any embodiment and the technical solution of other one or more embodiments is within the scope of protection of the present disclosure. Although the present disclosure has been described in detail with reference to general description and specific embodiments, it is obvious to those skilled in the art that modifications and improvements can be made on the basis of the present disclosure. Therefore, these modifications and improvements made without departing from the spirit of the present disclosure all belong to the scope of protection of the present disclosure.

What is claimed is:

1. A rotor blade for a subsonic compressor, the subsonic compressor comprising a hub and a casing, wherein a root of the rotor blade is arranged on the hub, a tip clearance is formed between a tip of the rotor blade and an inner wall of the casing, wherein
the tip clearance is shaped as a circumferential diverging leakage passage expanding from a pressure surface side of the rotor blade of the subsonic compressor at the tip to a suction surface side of the rotor blade at the tip.

2. The rotor blade for the subsonic compressor according to claim 1, wherein
the tip of the rotor blade has an obliquely cut face, and an included angle between the obliquely cut face and the inner wall of the casing is a chamfer angle α, wherein the chamfer angle α is equal to or less than 8 degrees.

3. The rotor blade for the subsonic compressor according to claim 1, wherein
a value of the tip clearance between the pressure surface side of the rotor blade at the tip and the inner wall of the casing is not less than a value of a radial clearance in a cold state of a rotor.

4. The rotor blade for the subsonic compressor according to claim 1,
the tip of the rotor blade is provided with a first extension surface extending toward the pressure surface side or a second extension surface extending toward the suction surface side.

5. A subsonic compressor, comprising the rotor blade for the subsonic compressor according to claim 1.

6. A method for flow stability enhancement based on obliquely cutting tips, which is applied to a subsonic compressor, the subsonic compressor comprising a hub, a casing and rotor blades, wherein a root of each of the rotor blades is provided on the hub, and a tip clearance is formed between a tip of the rotor blade and an inner wall of the casing, wherein
the method comprises cutting the tip of each of the rotor blades to form the tip clearance as a circumferential diverging leakage passage expanding from a pressure surface side to a suction surface side.

7. The method for flow stability enhancement based on obliquely cutting tips according to claim 6, wherein,
an edge line where a suction surface and a tip end surface of each of the rotor blades intersect with each other is a second cutting line, an edge line where a pressure surface and the tip end surface of each of the rotor blades intersect with each other is a first cutting line, the first cutting line and the second cutting line combine to form a reference stretching surface of the tip, and a leading edge point of the tip and a trailing edge point of the tip are connected to form a tip chord line;
cutting the tip comprises following steps:
taking the reference stretching surface as a rotating surface and taking the tip chord line as a rotating axis, wherein a forward direction of the rotating axis is directed from the leading edge point to the trailing edge point;
rotating the rotating surface in a clockwise direction around the rotating axis to form an oblique cutting surface, wherein an included angle between the oblique cutting surface and the reference stretching surface is a chamfer angle α; and
taking the oblique cutting surface as a cutting tool face to cut the tip of each of the rotor blades.

8. The method for flow stability enhancement based on obliquely cutting tips according to claim 7, wherein
the chamfer angle α is equal to or less than 8 degrees.

9. The method for flow stability enhancement based on obliquely cutting tips according to claim 7, wherein
a value of the tip clearance between the pressure surface side of the rotor blade at the tip and the inner wall of the casing is not less than a value of a radial clearance in a cold state of a rotor.

10. The method for flow stability enhancement based on obliquely cutting tips according to claim 7, wherein,
before cutting the tip, the method further comprises following steps:
extending the tip of each of the rotor blades toward the pressure surface side to form a first extension surface; or
extending the tip of each of the rotor blades toward the suction surface side to form a second extension surface.

11. The subsonic compressor, comprising the rotor blades of a subsonic compressor according to claim 5, wherein
the tip of the rotor blade has an obliquely cut face, and an included angle between the obliquely cut face and the inner wall of the casing is a chamfer angle α, wherein the chamfer angle α is equal to or less than 8 degrees.

12. The subsonic compressor, comprising the rotor blades of a subsonic compressor according to claim 5, wherein
a value of the tip clearance between the pressure surface side of the rotor blade at the tip and the inner wall of the casing is not less than a value of a radial clearance in a cold state of a rotor.

13. The subsonic compressor, comprising the rotor blades of a subsonic compressor according to claim 5,
the tip of the rotor blade is provided with a first extension surface extending toward the pressure surface side or a second extension surface extending toward the suction surface side.
